(19) United States
(12) Patent Application Publication
(10) Pub. No.: US 2014/0036301 A1
(43) Pub. Date: Feb. 6, 2014

(54) SYSTEM AND METHOD FOR MULTIPLE LOCATION, ON DEMAND PRINTING

(71) Applicant: Gustavo NIETO, Denville, NJ (US)

(72) Inventor: Gustavo NIETO, Denville, NJ (US)

(73) Assignee: THE PRUDENTIAL INSURANCE COMPANY OF AMERICA, Newark, NJ (US)

(21) Appl. No.: 13/563,168

(22) Filed: Jul. 31, 2012

(51) Int. Cl. H04W 88/00; G06K 15/02

(52) U.S. Cl. 358/1.15

(57) ABSTRACT

A printer for connection to a network to print documents residing on parts of the network has a connector for connection to the network, a log-in facility for a user to log in to the printer, a display for displaying a list of documents stored on a selected portion of a storage device on the network, and a print initiator to cause a selected document from the list of documents to be printed. The log-in facility, the display and the print initiator can be an integral part of the printer. Alternatively they can be a part of an apparatus connected between the network and the printer with the apparatus being other than a general purpose computer. A mobile telephone can have an application thereon for causing printing of documents by executing the steps of logging on, displaying a list of documents, and initiating printing of a selected document.

### BACKGROUND OF THE DISCLOSURE

1. Field of the Disclosure

The present disclosure relates to network wide document printing. More particularly, it relates to printers, and to apparatus and methods for exploiting printers, including multifunctional printers, on a network wide or enterprise wide basis.

2. Description of the Related Art

The efficient and convenient printing of documents on, for example, an enterprise wide basis presents several challenges. A central print facility, with a large sophisticated printer or printers, can be used. However, the need to deliver the printed material to various locations makes this method unduly burdensome.

A series of small, less costly and less sophisticated printers, each connected to a personal computer provides convenient, local printing, but may not address the need to print documents not stored on, or generally accessible to, the personal computer. Security concerns may limit accessibility to certain documents, sets of documents, or documents of a certain type.

Over time, these smaller, less costly and less sophisticated printers have acquired additional functionality. They permit a user to copy and print documents, to scan documents, and to fax documents, or with the aid of a personal computer, to e-mail documents, to various locations. However, the full capabilities of these printers is not being utilized with respect to the on-demand printing of documents that may be stored on servers or other, remote computers on an enterprise wide network.

A problem associated with the use of a large printer at a central print facility, or smaller printers connected to individual computers, is that an employee of a company generally will not have immediate access to documents for which a need arises during a business meeting, or at a time when the employee is away from his office or usual work station, or has traveled to a company office in a location other than the employee's home office. Retrieving and printing documents may then require locating someone who has access to a computer, and is cleared to receive that document. This may take undue time and effort, and may represent an imposition on that other employee's time. Another option would be to call an office assistant at the employee's home office, have the document printed, and then sent to the employee at a remote location, by e-mail or fax. This approach could produce undue delay, and again involves interrupting an office assistant's other duties.

### SUMMARY OF THE DISCLOSURE

In order to solve the problem of printing documents at various locations, each person on a network can have a folder where documents that may need to be printed, can be stored. A user can access a printer on the network to print one or more of the documents stored in the folder.

### BRIEF DESCRIPTION OF THE FIGURES

FIG. 1 is a combination block diagram and flow chart of an implementation of a first embodiment of the present disclosure.

FIG. 2 is a combination block diagram and flow chart of a second embodiment of the present disclosure.

FIG. 3 is a combination block diagram and flow chart of a third embodiment of the present disclosure.

FIG. 4 is a combination block diagram and flow chart of a fourth embodiment of the present disclosure.

A component or a feature that is common to more than one drawing is indicated with the same reference number, or a similar reference number, in each of the drawings.

### DETAILED DESCRIPTION OF THE EMBODIMENTS

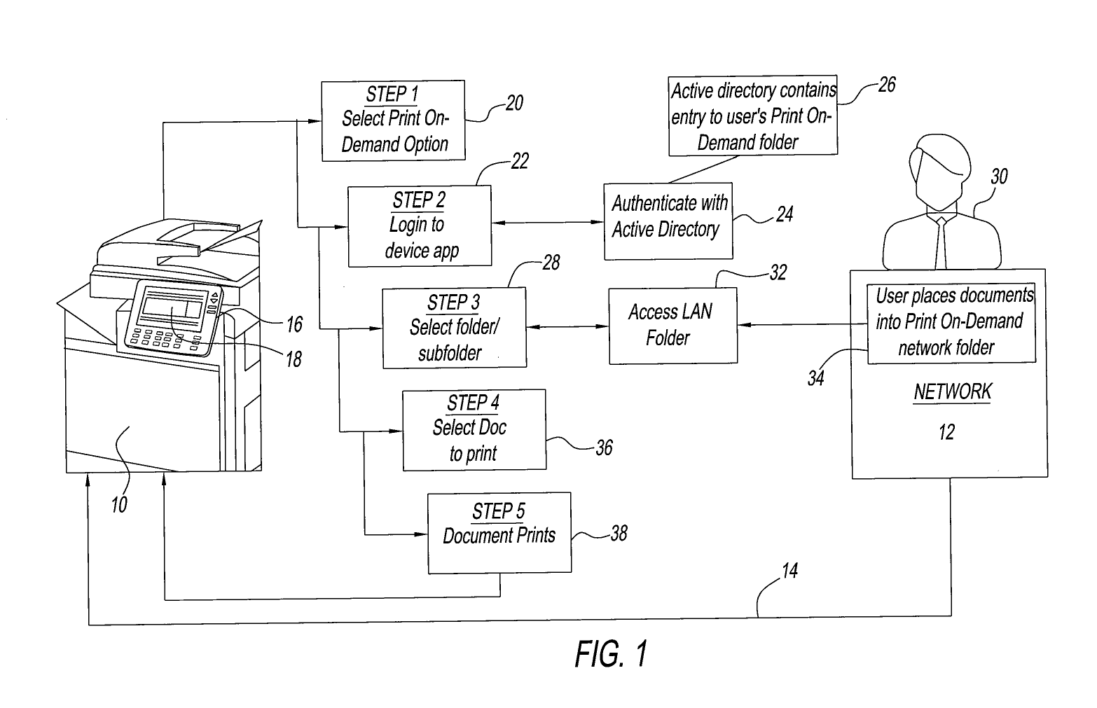

Referring to the figures and, in particular, FIG. 1, there is shown a printer generally referred to by reference numeral 10 (for example a multifunction printer), connected to a network 12 by a network cable 14. Network cable 14 may not be required in the case of a wireless connection of printer 10 to network 12. However, in such a wireless connection, adequate security precautions to maintain the confidential nature of the information being printed, such as standard encryption techniques, should be used.

Printer 10 has a control panel 16 with a touchscreen 18. Touchscreen 18 has a region to select 20 a print on demand option. When this option is selected, a login screen is presented to the user 22. If a recognized user name and password are entered, authentication with an active directory 24 takes place, which provides entry to the user's print on demand folder 26. This may be accomplished by way of an LDAP or active directory in which the user profile lists the user's personal parent directory that would be reflected on the printer 10. A utility may also provide the ability to set group directories that can be accessed by users based on active directory or LDAP user profiles.

Upon successful login, the user 30 has access to the folder 28, located anywhere on the network, which is accessed via the network 32, and contains the user's printable documents, which the user 30, at 34, previously placed into the print on demand network folder.

At 36, the user 30 selects a document to print by using the touchscreen 18 to highlight the document. At this point the document may print 38, either automatically upon selection, or by the user 30 touching a confirmation region on touchscreen 18.

While this embodiment is highly advantageous and solves the problems described above, it requires some modification to standard printers. Other disclosed embodiments, described below, require virtually no or minimal printer modifications. Such modification can be, in some cases, limited to changes in firmware.

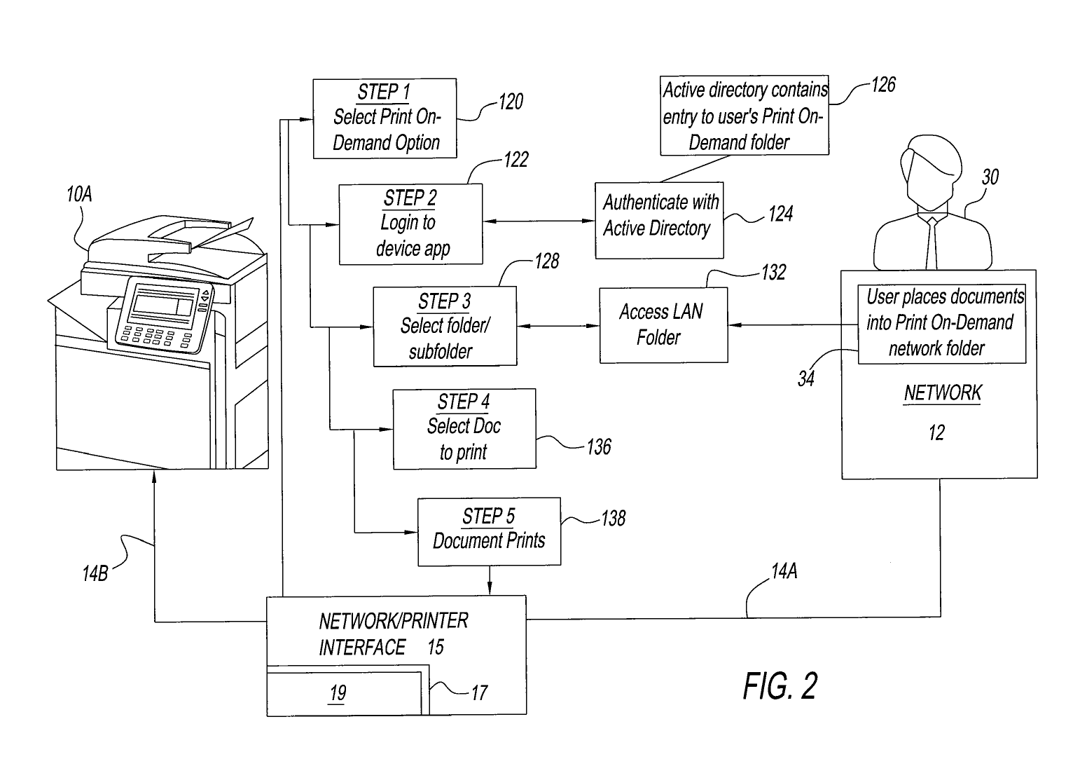

Referring to a second embodiment in FIG. 2, a standard or unmodified or off the shelf printer 10A is connected to network 12 by network cables 14A and 14B via a network/printer interface device 15. Instead of modifying printer 10A to be other than a standard printer, the required functionality described above with respect to printer 10 is provided by network/printer interface device 15. Network/printer interface device 15 includes a display panel 17 having a touchscreen 19. The operation of touchscreen 19 can be identical to that of touchscreen 18 of printer 10. The steps for a user 30 to print a document stored in the user's folder are identical to those described above with respect to FIG. 1, with identical steps being described by the same reference numeral indexed by one hundred to denote that it is the operation of network/printer interface device 15 that is being described, rather than that of printer 10 of FIG. 1.

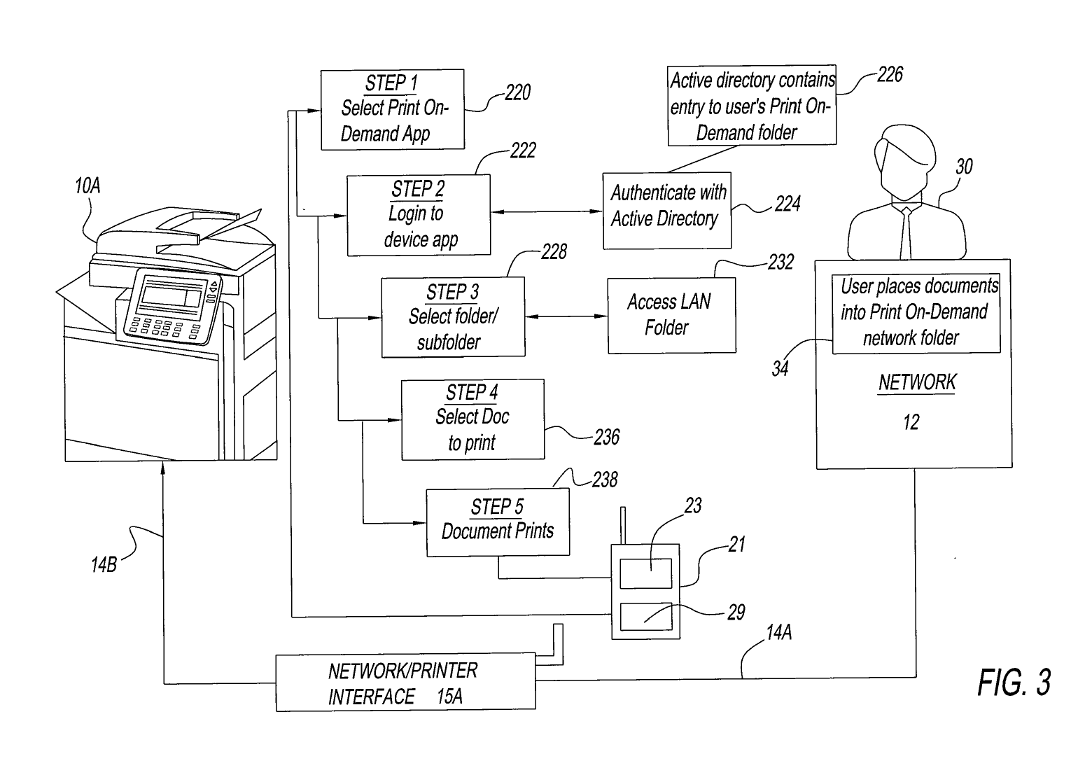

Referring to a third embodiment in FIG. 3, similar to that of FIG. 2, a standard, unmodified or off the shelf printer 10A is connected to the network 12 by network cables 14A and 14B via a simplified network/printer interface device 15A. Simplified network/printer interface device 15A performs the same functions as network/printer interface device 15 of FIG. 2, but there is no requirement that it have a display. Instead, simplified network/printer interface device 15A is connected to a smart mobile telephone 21 via a Wi-Fi connection. Mobile telephone 21 has a memory 29, a microprocessor (not shown) for processing in accordance with instructions in memory 29, and a touchscreen display 23. An application stored on mobile telephone 21, in memory 29, that is activated by using display 23 and possibly some keys (not shown) on mobile telephone 21, takes a user 30 through the same series of steps as illustrated and described with respect to FIG. 1. The identical steps in this embodiment are described by the same reference numeral indexed upward by two hundred, to denote that it is the operation of network/printer interface device 15A, via the application on mobile telephone 23 that is being described, rather than that of printer 10 of FIG. 1. There is one difference, in that at 220, it is a select Print On-Demand application on mobile telephone 21 that is activated.

The embodiment of FIG. 3 has the additional advantage of using a standard or unmodified printer but has an even simpler network/printer interface because a display and the user selection functions are provided by mobile telephone 21. Thus, the cost and complexity of this embodiment is even less than that of FIG. 2. Network/printer interface 15A is conveniently accessed by the user via a smart mobile telephone, when the user is at a remote location having access to the network.

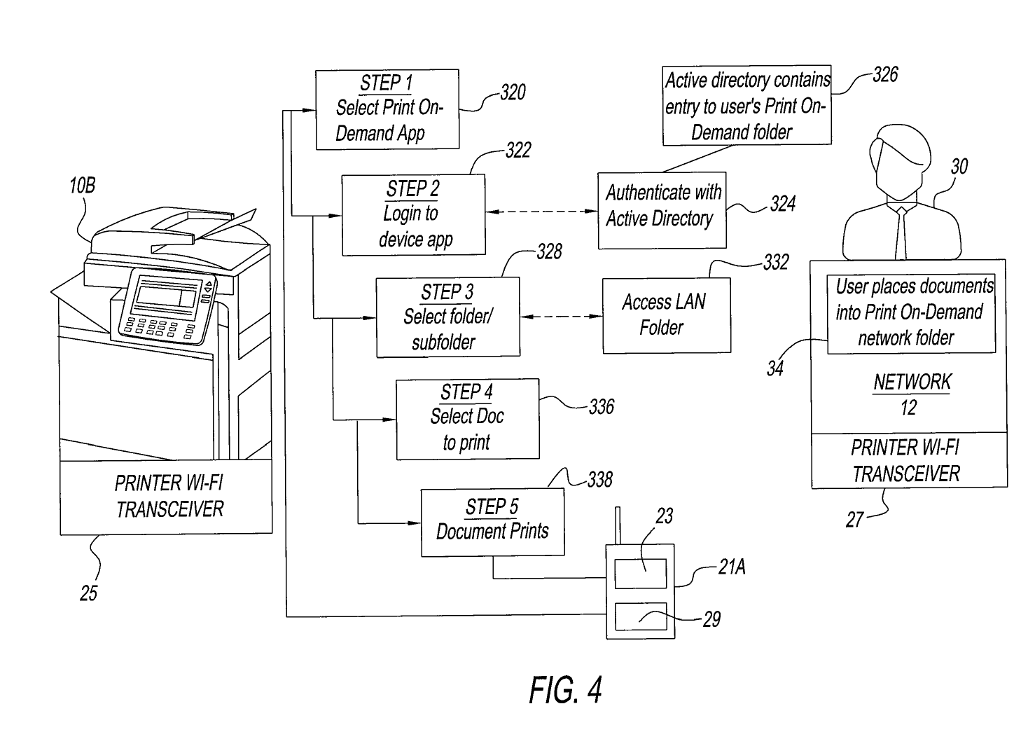

In the embodiment of FIG. 4, a standard printer 10A, has a printer wireless network transceiver or Wi-Fi transceiver 25. The network is also equipped with a network wireless transceiver or Wi-Fi transceiver 27. On-demand printing is initiated by an application on mobile telephone 21A, which connects to the network via one of Wi-Fi transceiver 25 or Wi-Fi transceiver 27. An application on mobile telephone 21A takes the user through the same steps as in FIG. 1, except that identical steps are described by the same reference numeral indexed upward by three hundred, to denote that it is the operation of the embodiment of FIG. 4, rather than that of FIG. 1, that is being described. However, steps 324, 326 and 332 are performed via network 12, rather than on mobile telephone 21A.

It is also possible for mobile telephone 21A to communicate with network 12 via a 3G or 4G telephone network, rather than with Wi-Fi.

The disclosed embodiments also can be used to integrate application documentation access or critical departmental documents, such as standard operating procedures in a common LDAP directory, that can be accessed by a group of authorized users. Thus, all authorized individuals in the group are able to print these documents at any company office having network access.

While the disclosed network is an enterprise wide network, the type of network is not so limited. It can include a local area network, a wide area network, a virtual private network, or the Internet.

It will be understood that the disclosure may be embodied in a computer readable non-transitory storage medium storing instructions of a computer program which when executed by a computer system results in performance of steps of the method described herein. Such storage media may include hard drives, flash drives, firmware, read only memory, random access memory, or any other storage device usable by a printer, a network printer interface, a smart phone, or storage device on the network, as described above. By way of example, and not by way of limitation, the computer readable non-transitory storage medium can be memory 29 of mobile telephone 21.

Thus, in order to solve the problem of printing documents at various locations, each person on an organization wide network can have a folder where documents that may need to be printed, can be stored. Printers on the network, regardless of size or complexity, can have or be associated with, a log-in facility on which users having a user name and password can log in to the printer. A display facility is associated with the log-in facility so that when the user has logged in, the directory for the folder containing the printable documents is displayed. A document selection function and a start print function are also available so that when a document that the user wishes to print has been selected, the document can be printed on the local printer.

The printer may be connected to the network with cables or wirelessly.

The log-in facility, the display and the print initiator can be integral parts of the printer. Alternatively, the log-in facility, the display and the print initiator can be a part of an apparatus, other than a general purpose computer, connected between the network and the printer.

The printer can have an interface device configured to communicate with a mobile telephone. The telephone can have an application for logging on to the printer, displaying a list of documents, and printing a document on the printer.

Thus, the present disclose provides a local printer for connection to a network to print documents residing on different parts of the network. The printer has a connector for connection to the network, a log-in facility for a user to log in to the printer; a display for displaying a list of documents stored on a selected portion of a storage device on the network, and a print initiator to cause a selected document from the list of documents to be printed by the printer. The selected portion is designated by that user. The logon facility, the display and the print initiator can be integral parts of the printer. Alternatively, the log-in facility, the display and the print initiator can be a part of an apparatus connected between the network and the printer. The apparatus can be other than a general purpose computer.

The printer can have an interface device between the network and the printer. The interface device can be configured to communicate with a mobile telephone. The telephone has an application thereon that uses a screen of the telephone to provide the log-in facility for a user to log in to the printer, a list of documents to be displayed, and a print initiator to cause a selected document from the list of documents, to be printed by the printer.

The printer can have a network radio communications facility for data communication with the network. A mobile telephone can be provided for communication with one of the network and the printer, the mobile telephone having an application for logging in to one of the network and the printer; displaying a list of documents stored on the selected portion of the storage device on the network; and initiating printing of a selected document from the list of documents.

In accordance with an aspect of one embodiment, a mobile telephone can have an application thereon for causing printing of documents stored on a selected portion of a storage device on a network, by a printer connected to a network, by executing the steps of logging on to one of the network and the printer; displaying a list of documents stored on the selected portion of the storage device on the network; and initiating printing of a selected document from the list of documents.

The present disclose is also directed to a method for printing documents from a local printer connected to a network, without the use of a local computer, including logging on to the network or the printer with a device having a presentation screen; displaying, on the presentation screen, a list of documents stored on a selected portion of a storage device on the network; and initiating printing of a selected document from the list of documents. The method also includes storing the documents to be printed in the storage device. The logging on, displaying and initiating can be performed by an employee of an organization at a location other than where the employee usually works. The logging on, displaying and initiating can be performed at a display on the printer or on an apparatus separate from and connected to the printer. The apparatus can be a mobile telephone which communicates with the apparatus. The logging on, displaying and initiating are performed by a mobile telephone that communicates with the network, or with the printer.

The techniques described herein are exemplary, and should not be construed as implying any particular limitation on the present disclosure. It should be understood that various alternatives, combinations and modifications could be devised by those skilled in the art. For example, steps associated with the processes described herein can be performed in any order, unless otherwise specified or dictated by the steps themselves. The present disclosure is intended to embrace all such alternatives, modifications and variances that fall within the scope of the appended claims.

What is claimed is:

1. A local printer for connection to a network to print documents residing on parts of the network, comprising:
a connector for connection to the network;
a log-in facility for a user to log in to the printer;
a display for displaying a list of documents stored on a selected portion of a storage device on the network, the selected portion designated for that user; and
a print initiator to cause a selected document from the list of documents, to be printed by the printer.

2. The printer of claim 1, wherein the log-in facility, the display and the print initiator are an integral part of the printer.

3. The printer of claim 1, wherein the login-in facility, the display and the print initiator are a part of an apparatus connected between the network and the printer, the apparatus being other than a general purpose computer.

4. The printer of claim 1, further comprising an interface device between the network and the printer, the interface device being configured to communicate with a mobile telephone, the telephone having an application thereon that includes a screen of the telephone to provide the log-in facility for a user to log in to the printer, the list of documents, and the print initiator.

5. The printer of claim 1, further comprising a network radio communications facility for data communication with the network.

6. The printer of claim 5, further comprising a mobile telephone for communication with the network radio communications facility, the mobile telephone having an application for:
logging on to the network;
displaying the list of documents; and
initiating printing of a selected document from the list of documents.

7. The printer of claim 1, further comprising a network communication facility for communicating with a mobile telephone, the mobile telephone including the log-in facility, the display and the print initiator.

8. The printer of claim 1, further comprising:
a first network radio communications facility connected to the printer; and
a second network radio communications facility for data communication with the network;
wherein one of the first network radio communications facility and the second network radio communications facility communicates with a mobile telephone, the mobile telephone having an application thereon that includes a screen of the telephone to provide the log-in facility for a user to log in to the printer, the list of documents, and the print initiator.

9. An apparatus for connection between a network and a local printer configured for printing documents on the network, comprising:
a user log-in facility;
a display for displaying a folder accessible to the user from which printable documents in the folder may be selected; and
a printing initiator for initiating printing of one or more selected documents in the folder, so that when printing is initiated, a document that has been selected is accessed and sent to the local printer for printing.

10. A mobile telephone having an application thereon for causing printing of documents stored on a selected portion of a storage device on a network, by a printer connected to a network, by executing the steps of:
logging on to one of the network and the printer;
displaying a list of documents stored on the selected portion of the storage device on the network; and
initiating printing of a selected document from the list of documents.

11. A computer readable non-transitory storage medium storing instructions of a computer program which when executed by a computer system associated with a network and a printer for printing documents stored on a storage device on the network, results in performance of steps of:
logging on to one of the network and the printer;
displaying a list of documents stored on the selected portion of the storage device on the network; and
initiating printing of a selected document from the list of documents.

12. A method for printing documents from a local printer connected to a network, without the use of a local computer, comprising:
logging on to one of the network and the printer with a device having a presentation screen;
displaying, on the presentation screen, a list of documents stored on a selected portion of a storage device on the network; and
initiating printing of a selected document from the list of documents.

13. The method of claim 12, further comprising storing documents to be printed in the storage device.

14. The method of claim 12, wherein the logging on, displaying and initiating are performed by an employee of an organization at a location other than where the employee usually works.

15. The method of claim 12, wherein the logging on, displaying and initiating are performed at a display on the printer.

16. The method of claim 12, wherein the logging on, displaying and initiating are performed at an apparatus separate from and connected to the printer.

17. The method of claim 16, wherein the apparatus is a mobile telephone which communicates with the apparatus.

18. The method of claim 12, wherein the logging on, displaying and initiating are performed by a mobile telephone that communicates with one of the network and the printer.
